(19) United States
(12) Patent Application Publication
(10) Pub. No.: US 2021/0097657 A1
(43) Pub. Date: Apr. 1, 2021

(54) CONTRAST ENHANCEMENT DEVICE AND DISPLAY

(71) Applicant: SHENZHEN CHINA STAR OPTOELECTRONICS TECHNOLOGY CO., LTD., Shenzhen, Guangdong (CN)

(72) Inventor: Xuebing ZHOU, Shenzhen, Guangdong (CN)

(21) Appl. No.: 16/095,476

(22) PCT Filed: Jul. 20, 2018
(86) PCT No.: PCT/CN2018/096435

§ 371 Date: Oct. 22, 2018

(30) Foreign Application Priority Data
Jun. 29, 2018 (CN) 201810699007.5

(51) Int. Cl. G06T 5/40; G06T 3/40

(52) U.S. Cl. CPC G06T 5/40; G06T 3/4038

(57) ABSTRACT

Disclosed are a contrast enhancement device and a liquid crystal display. The device includes: a storage module, storing an input image; a histogram module, performing histogram processing on the input image to obtain a histogram corresponding to the input image; a mapping module, performing mapping processing on the histogram to obtain a mapping table corresponding to the input image; a calculation module, performing interpolation processing on the input image according to the mapping table to obtain a target image; an image synchronization module, synchronizing the input image and the target image; and an image splicing module, splicing and outputting the input image and the target image. The device can implement a method for adjusting image contrast based on a local histogram by hardware circuit, thereby reducing the time for using software to improve image contrast, and meeting the requirements of real-time application of the product.

### CROSS REFERENCE

This application claims the priority of Chinese Patent Application No. 2018106990075, entitled “Contrast enhancement device and display”, filed on Jun. 29, 2018, of which is incorporated hereby incorporated in its entirety by reference.

### FIELD OF THE INVENTION

The present invention relates to an image process field, and more particularly to a contrast enhancement device and a display.

### BACKGROUND OF THE INVENTION

As processing the image, the contrast of the image has an important influence on the sharpness of the image and the detailed expression of the image. Generally speaking, the contrast is larger, the image is more clear and conspicuous, and the color is more vivid and bright. When the contrast is smaller, it will make the whole picture appear more blurred. Therefore, high contrast is very helpful for image sharpness, detail performance and gray level performance, and particularly for dynamic video, because the light and dark transition in the dynamic image is faster, the higher the contrast, the easier the human eye can distinguish such conversion process. The products with high contrast have more advantages in detail, clarity and performance of high-speed moving objects in some dark scenes. However, the methods of processing by software according to prior art to enhance image contrast have complicated processing procedures and cannot meet real-time requirements.

### SUMMARY OF THE INVENTION

The embodiment of the present invention provides a contrast enhancement device, which can implement image contrast enhancement in real time by using a hardware circuit.

First, the embodiment of the present invention provides a contrast enhancement device, comprising:

a storage module, configured to store an input image;

a histogram module, configured to perform histogram processing on the input image to obtain a histogram corresponding to the input image;

a mapping module, configured to perform mapping processing on the histogram to obtain a mapping table corresponding to the input image;

a calculation module, configured to perform interpolation processing on the input image according to the mapping table to obtain a target image with contrast enhancement;

an image synchronization module, configured to synchronize the input image and the target image; and

an image splicing module, configured to splice and output the input image and the target image.

Optionally, the histogram module specifically comprises:

a histogram creation sub-module, configured to divide the input image into M image blocks, and to perform histogram statistics on each image block to obtain M block histograms, wherein the M block histograms are in one-to-one correspondence with the M image blocks, and M is a positive integer greater than 1;

a histogram processing sub-module, configured to perform contrast restricting processing on each block histogram in the M block histograms, to obtain M restricted block histograms, wherein the M restricted block histograms are in one-to-one correspondence with the M image blocks.

Optionally, the mapping module specifically comprises:

a histogram mapping sub-module, configured to perform equalization processing on the restricted block histograms to obtain M block mapping tables;

a filtering sub-module, configured to filter the M block mapping tables to obtain M filtering mapping tables.

Optionally, the contrast enhancement device further comprises: a histogram storage module, configured to store data of the M block histograms, data of the M restricted block histograms and data of the M block mapping tables in time division.

Optionally, the contrast enhancement device further comprises: a filtering mapping table storage module, configured to store the M filtering mapping tables.

Optionally, the calculation module is specifically configured to interpolate the input image according to the M filtering mapping tables to obtain the target image with contrast enhancement.

Optionally, the storage module stores the input image using a double data rate synchronous dynamic random access memory (Double Data Rate, DDR).

Optionally, the data of the block histograms, the data of the restricted block histograms, and the data of the block mapping tables are stored in a static random access memory (SRAM).

Optionally, the contrast enhancement device further comprises; a timing control module, configured to generate control signals required by the respective modules according to data of the input image.

Optionally, the contrast enhancement device further comprises: an image alignment module, configured to align the data of the input image with the control signal, and sending the data of the input image to the storage module by taking one row as one unit.

Second, the embodiment of the present invention provides a display. The display comprises the aforesaid contrast enhancement device.

The embodiment of the present invention provides a contrast enhancement device. The histogram module performs histogram processing on the input image in the storage module to obtain the histogram corresponding to the input image; then, the mapping module performs mapping processing on the histogram to obtain the mapping table corresponding to the input image; and then, the calculation module performs interpolation processing on the input image according to the mapping table to obtain the target image with contrast enhancement. The device of the present invention can implement a method for adjusting image contrast based on a local histogram by hardware such as a Field-Programmable Gate Array (FPGA) or a Graphics Processing Unit (GPU), thereby reducing the time for using software to improve image contrast, and meeting the requirements of real-time application of the product.

### BRIEF DESCRIPTION OF THE DRAWINGS

In order to more dearly illustrate the embodiments of the present invention; the following figures will be described in the embodiments are briefly introduced. It is obvious that the drawings are some embodiments of the present invention, those of ordinary skill in this field can obtain other figures according to these figures without paying the premise.

FIG. 1 is a schematic structural diagram of a contrast enhancement device according to the embodiment of the present invention;

FIG. 2 is a schematic diagram of image block division according to the embodiment of the present invention;

FIG. 3 is a schematic structural diagram of another contrast enhancement device according to the embodiment of the present invention;

FIG. 4 is a block histogram and a restricted block histogram corresponding to an image block before and after performing contrast restricting processing on an image block according to the embodiment of the present invention;

FIG. 5 is a schematic diagram of data storage of a histogram storage module according to the embodiment of the present invention;

FIG. 6 is a schematic diagram of data reading according to the embodiment of the present invention;

FIG. 7 is a schematic diagram of a neighborhood replication data according to the embodiment of the present invention;

FIG. 8 is a schematic diagram of image block neighborhood processing according to the embodiment of the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

The terms “comprising” and “including”, when used in the specification and the claims, indicates the presence or addition of a plurality of other features, integers, steps, operations, elements, components and/or collections thereof. The existence or addition of one or more other features, integers, steps, operations, elements, components and/or collections thereof are not excluded.

It should also be understood that the terms used in the specification of the present invention are only for the purpose of describing specific embodiments and are not intended to limit the invention. As used in the description of the present invention and the accompanying claims, unless the context clearly indicates otherwise, the singular form “one”, “one kind” and “the” are intended to include the plural form.

It is further understood that the term “and/or” used in the description of the invention and the appended claims means any combination and all possible combinations of one or more of the associated listed items, and includes these combinations.

Please refer to FIG. 1. FIG. 1 is a schematic structural diagram of a contrast enhancement device according to the embodiment of the present invention. As shown in FIG. 1, the device comprises: a storage module 101, a histogram module 102, a mapping module 103, a calculation module 104, an image synchronization module 105 and an image splicing module 106, wherein

a storage module 101, configured to store an input image;

a histogram module 102, configured to perform histogram processing on the input image to obtain a histogram corresponding to the input image;

a mapping module 103, configured to perform mapping processing on the histogram to obtain a mapping table corresponding to the input image;

a calculation module 104, configured to perform interpolation processing on the input image according to the mapping table to obtain a target image:

an image synchronization module 105, configured to synchronize the input image and the image with contrast enhancement; and

an image splicing module 106, configured to splice and output the input image and the target image.

In the embodiment of the present invention, the storage module 101 can be a double data rate synchronous dynamic random access memory (Double Data Rate, DDR) for storing the input image and managing storage and reading of the input image.

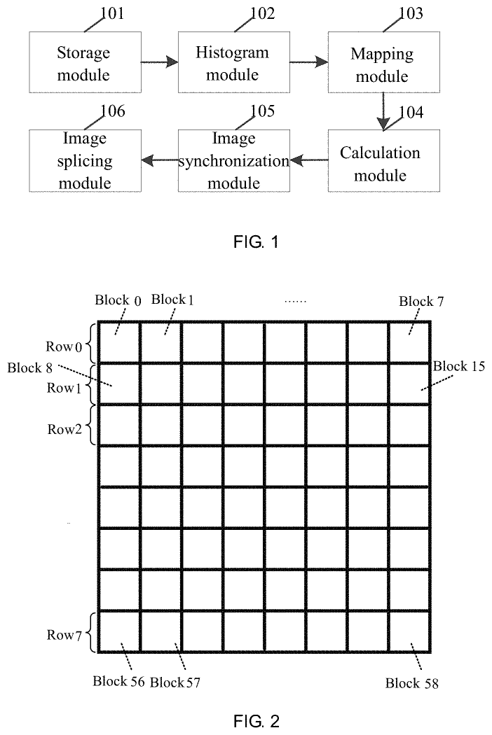

In the embodiment of the present invention, the histogram module 102 is used to divide an image into multiple image blocks. For an illustration, as shown in FIG. 2, FIG. 2 is a schematic diagram of image block division according to the embodiment of the present invention. In FIG. 2, the image is divided into 8*8 image blocks, and the eight image blocks in the same horizontal direction are collectively referred to as a block row. The 64 image blocks are divided into 8 block rows, which are row0, row1, . . . , row7, and 64 image blocks are numbered block0, block2, . . . , block63 from left to right and from top to bottom. Namely, the 8 blocks in the first block row at the upper part of the divided image are numbered as block0-block7, the 8 blocks in the second block row are numbered as block8-block15, . . . , and so on, and the 8 blocks in the eighth block row are numbered block56-block63. After the image is divided into blocks, the histogram module 102 performs histogram statistics on the 64 image blocks to obtain histograms of the corresponding 64 image blocks.

In the embodiment of the present invention, after obtaining the histogram data of the 64 image blocks, the mapping module 103 performs equalization processing on the histogram data of each image block to obtain 64 block mapping tables (BMTs) corresponding to the input image. Then, the 64 block mapping tables are smoothing filtered to obtain corresponding 64 filtering mapping tables after filtering.

In the embodiment of the present invention, after the mapping module 103 obtains the filtering mapping table corresponding to each image block of the input image, the calculation module 104 reads the input image from the storage module 101, and interpolates and calculate each image block of the input image according to the filtering mapping table to obtain a target image with contrast enhancement after the interpolation processing.

In the embodiment of the present invention, after obtaining the target image, the image synchronization module 105 reads the input image from the storage module 101, and synchronizes the input image and the target image with contrast enhancement under the action of the control signal generated by the timing control module, and then, the input image and the target image are synchronously input to the image splicing module 106.

In the embodiment of the present invention, the image splicing module 106 is configured to splice the input image and the target image input by the image synchronization module and to output the same for display. It should be understood that the aforesaid splicing the input image and the target image is performed by simultaneously outputting the input image and the target image so that the input image and the target image are displayed on the same display interface.

It can be understood that the method for performing smoothing filtering on the block mapping table by the mapping module 103 includes, but is not limited to, mean filtering, Gaussian filtering, median filtering and bilateral filtering. The method for interpolating and calculating the input image by the calculation module 104 includes, but is not limited to, the most proximity interpolation, bilinear interpolation and cubic convolution interpolation.

In the embodiment of the present invention, the image is divided into blocks during the effective image time of the nth image F(n), and histogram statistics, histogram restriction and histogram equalization processing are performed for each block. In the vertical blanking time of the image F(n), the mapping table obtained by the histogram equalization is smoothing filtered, and a filtering mapping table is obtained. In the effective time of the n+1th image F(n+1), the image F(n+1) is divided into blocks. While histogram statistics, histogram restriction and histogram equalization processing are performed on each block of the image F(n+1), the image F(n) is read from the storage module, and the interpolation is performed by using the filtering mapping table corresponding to the image F(n) to obtain the target image corresponding to the image F(n) with contrast enhancement.

The embodiment of the present invention provides a contrast enhancement device, and the histogram module divides the input image in the storage module into the plurality of image blocks, and performs histogram processing on each image block to obtain the histogram corresponding to each image block of the input image; then, the mapping module performs mapping processing on the histogram of each image block a to obtain a mapping table corresponding to the input image; and then, the calculation module performs interpolation processing on the input image according to the mapping table to obtain the target image with contrast enhancement. The device of the present invention can implement a method for adjusting image contrast based on a local histogram by hardware such as an FPGA or a GPU, thereby reducing the time for using software to improve image contrast, and meeting the requirements of real-time application of the product. Furthermore, the device of the embodiment of the present invention further includes an image synchronization module and an image splicing module, configured to splice the contrast-enhanced target image and the input image and to synchronously output the same for display, so as to compare the effects before and after the contrast enhancement of the image.

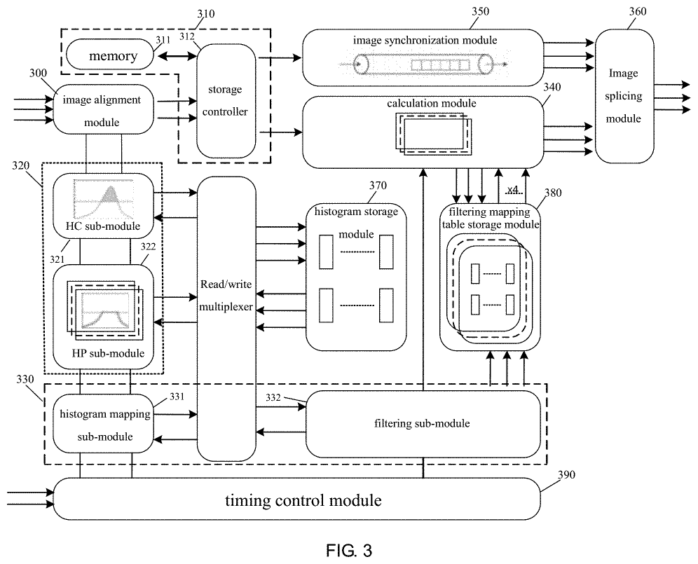

Please refer to FIG. 3. FIG. 3 is a schematic structural diagram of another contrast enhancement device according to the embodiment of the present invention. As shown in FIG. 3, the device includes a storage module 310, a histogram module 320, a mapping module 330, a calculation module 340, an image synchronization module 350 and an image splicing module 360; wherein,

a storage module 310, configured to store an input image;

a histogram module 320, configured to perform histogram processing on the input image to obtain a histogram corresponding to the input image;

a mapping module 330, configured to perform mapping processing on the histogram to obtain a mapping table corresponding to the input image;

a calculation module 340, configured to perform interpolation processing on the input image according to the mapping table to obtain a target image;

an image synchronization module 350, configured to synchronize the input image and the image with contrast enhancement; and

an image splicing module 360, configured to splice and output the input image and the target image.

In the embodiment of the present invention, the storage module 310 includes a memory 311 and a storage controller 312. The memory 311 may be a double data rate synchronous dynamic random access memory for storing the input image, and the storage controller is configured to manage storage and reading of the input image.

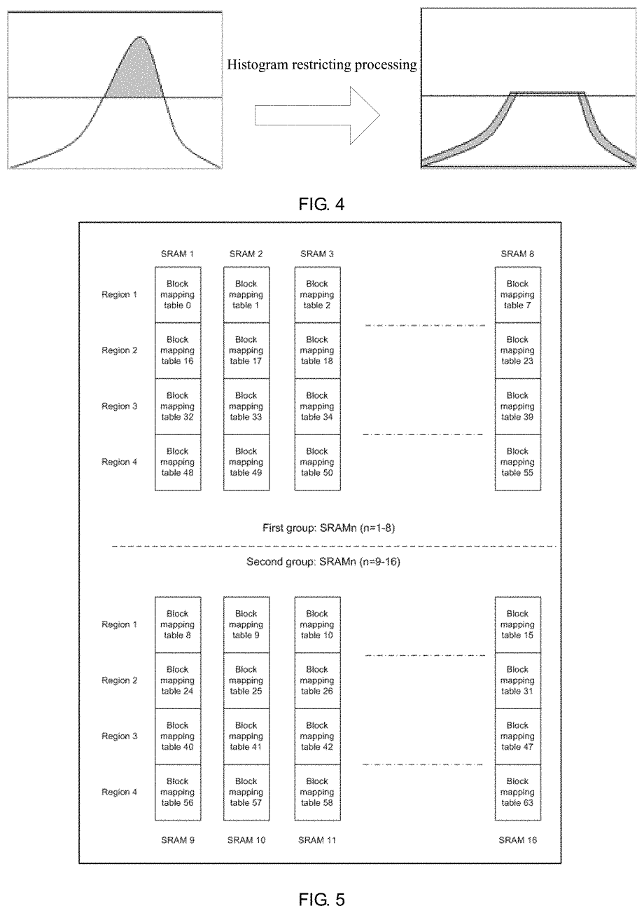

In the embodiment of the present invention, the histogram module 320 includes a histogram creation sub-module 321 and a histogram processing sub-module 322, wherein the histogram creation sub-module 321 is configured to divide the input image into a plurality of image blocks, and to perform histogram statistics on each image block to obtain a block histogram corresponding to each image block. The histogram processing sub-module 322 performs contrast restricting processing on each image block according to a preset value to obtain a restricted block histogram of each image block. As shown in FIG. 4, FIG. 4 is a block histogram and a restricted block histogram corresponding to an image block before and after performing contrast restricting processing on an image block according to the embodiment of the present invention. It should be understood that the method for dividing the image into the image blocks has been described in the previous embodiment, and is not described herein again. In the embodiment of the present invention, the input image divided into 64 image blocks is illustrated for describing the processing of this embodiment.

In the embodiment of the present invention, the mapping module 330 includes a histogram mapping sub-module 331 and a filtering sub-module 332. The histogram mapping sub-module 331 is configured to perform equalization processing on the restricted block histogram to obtain 64 block mapping tables with a depth K corresponding to the input image, wherein K is the same as the number of gray levels in the histogram; the filtering sub-module 332 performs filtering processing on the 64 block mapping tables to obtain corresponding 64 filtering mapping tables.

In the embodiment of the present invention, the contrast enhancement device further comprises a histogram storage module 370, configured to store data of the M block histograms, data of the M restricted block histograms and data of the M block mapping tables in time division.

It can be understood that, in this embodiment, the block histograms, the restricted block histograms, and the block mapping tables may be stored in the histogram storage module 370 in a time division to save hardware resources. Namely, when the histogram creation sub-module 321 performs histogram statistics on each image block separately to obtain a block histogram corresponding to each image block, the histogram storage module 370 is configured to store data of the block histogram corresponding to each image block; when the histogram processing sub-module 322 performs contrast restricting processing on each image block according to the preset value to obtain the corresponding restricted block histogram for each block, the histogram storage module 370 is configured to store data of the restricted block histogram instead of data of the block histogram; the histogram mapping sub-module 331 is configured to perform equalization processing on the restricted block histogram to obtain 64 block mapping tables with a depth K corresponding to the input image, and the histogram storage module 370 is configured to store data of the block mapping tables instead of data of the restricted block histogram. The manner in which the histogram storage module 370 stores data is as shown in FIG. 5. Storing block mapping table is illustrated, the 64 block mapping tables obtained after the equalization processing may be numbered BMT0, BMT1, . . . , BMT63, respectively. The 64 block mapping tables correspond to 64 image blocks one-by-one. According to the correspondence between the 64 block mapping tables and the corresponding image blocks, the 64 block mapping tables may be stored in 16 static random access memories (SRAM). As shown in FIG. 5, the 16 SRAMs are numbered SRAM1, SRAM2, SRAM16, respectively, and are divided into two groups of the first group and the second group, wherein SRAM1 to SRAM8 are the first group, and SRAM8 to SRAM16 are the second group, and each SRAM is divided into four storage areas, and each storage area number is Regionx (x=1, 2, 3, 4), and then 16 SRAMs have 64 storage areas, and 64 mapping tables are stored in 64 storage areas as shown in FIG. 5. The block mapping table corresponding to the image block of the even-numbered block row is stored in the first group, and the block mapping table corresponding to the image block of the odd-numbered block row is stored in the second group.

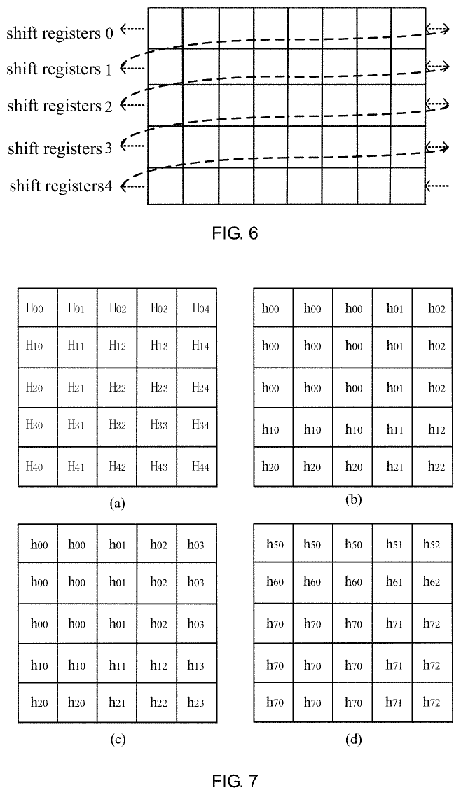

Furthermore, in the embodiment of the present invention, five sets of barrel shift registers are designed to read data of the mapping tables in the histogram storage module 370 to form a mapping matrix of 8*8. As shown in FIG. 6, the corresponding numbers of the five barrel shift registers are RegBarrelShifter0, RegBarrelShifter1, RegBarrelShifter4, and the depth of each barrel shift register is 8, and the data is read by from the right side to the left side. Particularly, the five sets of barrel shift registers are concatenated end-to-end and simulated in a queue mode, which specifically is: the left output of RegBarrelShifter4 is connected to the right input of RegBarrelShifter3, and so on, the right input of RegBarrelShifter4 serves as an input port of the simulated queue, and the left output of RegBarrelShifter0 serves as an output of the simulated queue. The manner of reading the mapping data from the 16 SRAMs is described as the following: according to the positional relationship of the image blocks, the data in the Region1 of the SRAM1-SRAM8 in the first group is sequentially read and sequentially sent to the simulated queue; and then, the data in Region1 of SRAM9-SRAM16 in the second group sequentially read and sequentially sent to the simulated queue: and then, the data in Region2 in the first group and the second group is read in turn, and so on, until the data in all the storage areas is read; at this time, an 8*8 mapping matrix data has been read.

In the embodiment of the present invention, the device further includes a filtering mapping table storage module 380, configured to store the filtering mapping tables. After acquiring the mapping matrix corresponding to the input image, the filtering sub-module 332 performs filtering calculation on the mapping matrix of 8*8, for example, filtering the mapping matrix by using Gaussian filtering to obtain 64 Gaussian filtering mapping tables, and 64 Gaussian filtering mapping tables is stored in another 16 SRAMs according to the correspondence of image blocks.

Specifically, when Gaussian filtering is performed, the Gaussian filtering adopts a filtering window of 5*5, and the first five rows and five columns of the barrel shift register RegBarrelShifter0-RegBarrelShifter4 are arranged into a 5*5 data structure. Corresponding to the Gaussian filtering 5*5 in the filtering window, each position of the 5*5 data structure is numbered as Hmn (m=0˜4, n=0˜4), where m represents the number of rows and n represents the number of columns, and the center position of the Gaussian filtering window corresponds to the H22 position of the 5*5 data structure. The data in the 8*8 mapping matrix is numbered hij (i=0˜7, j=0˜7), where i represents the number of rows and j represents the number of columns. When the data h00 of the first row, the first column of the mapping matrix read by the barrel shift register is moved to the center point position of the Gaussian filtering window corresponding to H22, the Gaussian filtering operation is started, and only the data in the rectangular region of the lower right corner of the H22 position is valid, and the data located in other positions of the Gaussian filtering window is performed by neighborhood replication. The data after replication of the neighborhood replication is shown in FIG. 7. (a) in FIG. 7 is a positional relationship diagram of the 5*5 data structure, and (b) in FIG. 7 is the data in the 5*5 data structure after the neighborhood replication when h00 is moved to the H22 position. (c) in FIG. 7 is the data in the 5*5 data structure after neighborhood replication when h01 is moved to the H22 position. (d) in FIG. 7 is the data in the 5*5 data structure after the neighborhood replication when h70 moves to the H22 position. The Gaussian filtering filters the data of the mapping matrix from left to right and top to bottom. In the embodiment of the present invention, the Gaussian filtering coefficient table is optimized to a Gaussian integer coefficient table. In the hardware implementation, a simple shift and an addition method are used to achieve the multiplication operation, and no additional multiplier resources are needed. The Gaussian filtering calculation for the 8*8 mapping matrix with the depth K only needs K*64 clock cycles, which can ensure that the filtering operation of the mapping matrix is completed before the end of the vertical blanking time of the image to obtain the Gaussian filtering mapping table.

It can be understood that the foregoing SRAM can adopt any one of a simple dual port memory, a true dual port memory and a single port memory.

In the embodiment of the present invention, the calculation module 340 performs interpolation on the input image according to the Gaussian filtering mapping table, and obtains a contrast enhanced target image after the interpolation. Specifically, the calculation module 340 divides each image block into 4 sub-blocks of 2*2, and determines the upper left corner, the upper right corner, the lower left corner and the lower right corner of the current sub-block according to the position of the current sub-block that is interpolated, and then determines four Gaussian filtering mapping tables corresponding to the image blocks to which the four neighborhood sub-blocks belong. The four Gaussian filtering mapping tables are named TL (Top Left), TR (Top Right), BL (Bottom Left) and BR (Bottom Right), and the current sub-blocks are interpolated according to the four Gaussian filtering mapping tables to obtain the target image.

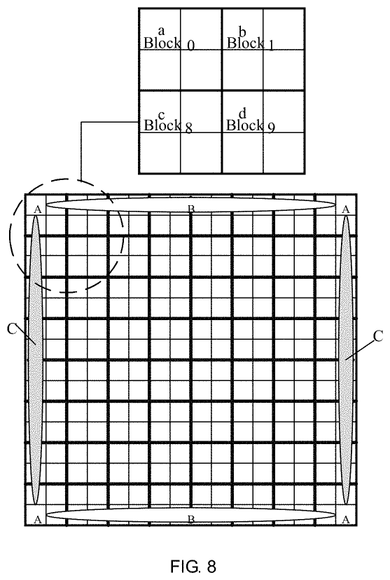

It can be understood that after the image blocks are divided into sub-blocks, the positions of the sub-blocks can have four conditions. As shown in FIG. 8, FIG. 8 is a schematic diagram of image block neighborhood processing according to the embodiment of the present invention. The four positions are position A, position B, position C and position D, respectively, where position A corresponds to the position of four sub-blocks in the four corners of the image, and the image block at position A has only three adjacent sub-blocks; position B and position C correspond to the positions of the sub-blocks on the four sides of the image (excluding the sub-blocks at the four corners), and the sub-blocks of position B and position C have five adjacent sub-blocks; position D corresponds to the positions of the sub-blocks other than position A, position B and position C in the image, and the sub-blocks of position D has eight adjacent sub-blocks. Correspondingly, the Gaussian filtering mapping tables corresponding to the sub-blocks of the above four locations also have four conditions: TL, TR, BL and BR are the same in the four Gaussian filtering mapping tables corresponding to the location A; in the Gaussian filtering mapping tables, TL and BL are the same, and TR and BR are the same; in the four Gaussian filtering mapping tables corresponding to position C, TL and TR are the same, and BL and BR are the same; and in the four Gaussian filtering mapping tables corresponding to position D, TL, TR, BL, BR are different. As an illustration, as shown in FIG. 8, the image block block0 and the four sub-blocks in the image block adjacent to block0 are illustrated, and the sub-block a in the block 0 corresponds to position A, and TL, TR, BL and BR of the sub-block a are the Gaussian filtering mapping tables corresponding to the block 0; the sub-block b in the block 1 corresponds to position B, and TL and BL of the sub-block b correspond to the Gaussian filtering mapping table corresponding to the block 0, and TR and BR correspond to the Gaussian filtering mapping table corresponding to the block 1; the sub-block c in the block 8 corresponds to position C, TL and TR of the sub-block c correspond to the Gaussian filtering mapping table corresponding to the block 0, and BL and BR correspond to the Gaussian filtering mapping table corresponding to the block 8; the sub-block d in the block 9 corresponds to position 0, and TL of the sub-block d corresponds to the Gaussian filtering map table corresponding to the block 0, TR corresponds to the Gaussian filtering map table corresponding to the block 1, and BL corresponds to the Gaussian filtering map table corresponding to the block 8, and BR corresponds to the Gaussian filtering mapping table corresponding to the block 9.

It can be understood that the method for interpolating and calculating the input image by the calculation module 340 includes, but is not limited to, the most proximity interpolation, bilinear interpolation and cubic convolution interpolation.

In the embodiment of the present invention, after obtaining the target image, the image synchronization module 350 reads the input image from the storage module 310, and synchronizes the input image and the target image with contrast enhancement under the action of the control signal generated by the timing control module, and then, the input image and the target image are synchronously input to the image splicing module 360.

In the embodiment of the present invention, the image splicing module 360 is configured to splice the input image and the target image input by the image synchronization module and to output the same for display. It should be understood that the aforesaid splicing the input image and the target image is performed by simultaneously outputting the input image and the target image so that the input image and the target image are displayed on the same display interface.

Optionally, the contrast enhancement device may further comprise a timing control module 390, configured to generate control signals required by the respective modules according to data of the input image.

Optionally, the contrast enhancement device may further comprise an image alignment module 300, configured to align the data of the input image with the control signal, and sending the data of the input image to the storage module 310 by taking one row as one unit.

The embodiment of the present invention provides a contrast enhancement device. The histogram creation sub-module divides the input image in the storage module into a plurality of image blocks, and performs histogram processing on each image block to obtain a histogram corresponding to each image block of the input image, and the histogram processing sub-module performs contrast restricting processing on each image block according to a preset value to obtain a restricted block histogram of each block; then, the histogram mapping sub-module performs mapping processing on the histogram of each image block to obtain a block mapping table corresponding to each image block, and the filtering sub-module performs filtering processing on the block mapping table to obtain a filtering mapping table corresponding to the image block; and then the calculation module performs interpolation processing on each image block of the input image according to the filtering mapping table to obtain a target image with contrast enhancement. The device of the present invention can implement a method for adjusting image contrast based on a local histogram by hardware such as an FPGA or a GPU, thereby reducing the time for using software to improve image contrast, and meeting the requirements of real-time application of the product. Furthermore, the device of the embodiment of the present invention further includes an image synchronization module and an image splicing module, configured to splice the contrast-enhanced target image and the input image and to synchronously output the same for display, so as to compare the effects after the contrast enhancement of the image.

Based on the same inventive concept, the present invention further provides a display, and the liquid crystal display includes the modules provided in the foregoing embodiments. For details, refer to the related description in the foregoing embodiments, and details are not described herein again.

Optionally, since the image synchronization module and the image splicing module in the aforesaid device are configured to synchronously output the input image and the target image with contrast enhancement, for display at the same time. If the display is applied in an experimental instrument, the image synchronization module and the image splicing module are included, which is convenient for the experimenter to compare the input image with the target image. If the display is applied in the home appliance, the display may not include the image synchronization module and the image splicing module, and the display is only used to display the target image after the contrast enhancement.

Those skilled in the art will appreciate that the units and algorithm steps of each illustration described in connection with the embodiments disclosed herein can be implemented in electronic hardware, computer software, or a combination of the two. In order to clearly illustrate the hardware and software Interchangeability, the composition and steps of each illustration have been described in terms of functionality in the above description. Whether these functions are performed by hardware or software depends upon the particular application and design condition of the technical solution. Those skilled may use different methods to implement the described functions for each particular application but such implementations should not be considered beyond the scope of the present invention.

In several embodiments provided in this application, it should be understood that the disclosed device, module and display may be implemented in other ways. As an illustration, the embodiment of the device described above is merely illustrative. For example, the division of the module is only a logical function division and there are additional ways of actual implement, such as, multiple modules or components may be combined or can be integrated into another system. Or, some feature can be ignored or not executed. In addition, the coupling, the direct coupling or the communication connection shown or discussed may be either an indirect coupling or a communication connection through some interfaces, devices or modules, or may be electrically, mechanically or otherwise connected.

The modules described as the separation means may or may not be physically separated. The components shown as units may or may not be physical modules, i.e., may be located in one place or may be distributed over a plurality of network units. The part or all of the units can be selected according to the actual demands to achieve the object of the embodiment of the present invention.

The respective function units in the respective embodiments of the present invention can be integrated in one process unit, or the individual units are physically present, or two or more units are integrated in one unit. The foregoing integrated units can be implemented in the form of hardware or in the form of a software functional unit.

The integrated unit may be stored in a computer readable storage medium if implemented in the form of a software functional unit and sold or used as a stand-alone product. Based on such understanding, the technical solution of the present invention contributes in essence or to the prior art, or all or part of the technical solution may be embodied in the form of a software product stored in a storage medium. A number of instructions are included therein to cause a computer device (which may be a personal computer, server or network device, etc.) to perform all or part of the steps of the methods described in various embodiments of the present invention. The foregoing storage medium includes: a U disk, a mobile hard disk, a read-only memory (ROM), a random access memory (RAM), a magnetic disk or an optical disk, which can store program code.

The foregoing descriptions are merely the specific embodiments of the present invention. However, the present invention is not limited thereby. Any modifications, equivalent replacements or improvements within the spirit and principles of the embodiment described above, which can be easily derived by those skilled persons in this art from the technical field disclosed in the present invention should be covered by the protected scope of the invention. Thus, the patent protection scope of the present invention should be subjected to what is claimed is.

What is claimed is:

1. A contrast enhancement device, comprising:
a storage module, configured to store an input image;
a histogram module, configured to perform histogram processing on the input image to obtain a histogram corresponding to the input image;
a mapping module, configured to perform mapping processing on the histogram to obtain a mapping table corresponding to the input image;
a calculation module, configured to perform interpolation processing on the input image according to the mapping table to obtain a target image with contrast enhancement;
an image synchronization module, configured to synchronize the input image and the target image; and
an image splicing module, configured to splice and output the input image and the target image.

2. The contrast enhancement device according to claim 1, wherein the histogram module comprises:
a histogram creation sub-module, configured to divide the input image into M image blocks, and to perform histogram statistics on each image block to obtain M block histograms, wherein the M block histograms are in one-to-one correspondence with the M image blocks, and M is a positive integer greater than 1;
a histogram processing sub-module, configured to perform contrast restricting processing on each block histogram in the M block histograms, to obtain M restricted block histograms, wherein the M restricted block histograms are in one-to-one correspondence with the M image blocks.

3. The contrast enhancement device according to claim 2, wherein the mapping module comprises:
a histogram mapping sub-module, configured to perform equalization processing on the restricted block histograms to obtain M block mapping tables;
a filtering sub-module, configured to filter the M block mapping tables to obtain M filtering mapping tables.

4. The contrast enhancement device according to claim 3, further comprising:
a histogram storage module, configured to store data of the M block histograms, data of the M restricted block histograms and data of the M block mapping tables in time division.

5. The contrast enhancement device according to claim 4, wherein the data of the block histograms, the data of the restricted block histograms, and the data of the block mapping tables are stored in a static random access memory (SRAM).

6. The contrast enhancement device according to claim 4, further comprising:
a filtering mapping table storage module; configured to store the M filtering mapping tables.

7. The contrast enhancement device according to claim 6, wherein the calculation module is configured to:
interpolate the input image according to the M filtering mapping tables to obtain the target image with contrast enhancement.

8. The contrast enhancement device according to claim 1, wherein the storage module stores the input image using a double data rate synchronous dynamic random access memory (DDR).

9. The contrast enhancement device according to claim 6, further comprising:
a timing control module, configured to generate control signals required by the respective modules according to data of the input image.

10. The contrast enhancement device according to claim 9, further comprising:
an image alignment module, configured to align the data of the input image with the control signal, and sending the data of the input image to the storage module by taking one row as one unit.

11. A display, comprising a contrast enhancement device, wherein the contrast enhancement device comprises:
a storage module, configured to store an input image;
a histogram module, configured to perform histogram processing on the input image to obtain a histogram corresponding to the input image;
a mapping module, configured to perform mapping processing on the histogram to obtain a mapping table corresponding to the input image;
a calculation module, configured to perform interpolation processing on the input image according to the mapping table to obtain a target image with contrast enhancement;
an image synchronization module, configured to synchronize the input image and the target image; and
an image splicing module, configured to splice and output the input image and the target image.

12. The display according to claim 11, wherein the histogram module comprises:
a histogram creation sub-module, configured to divide the input image into M image blocks, and to perform histogram statistics on each image block to obtain M block histograms, wherein the M block histograms are in one-to-one correspondence with the M image blocks, and M is a positive integer greater than 1;
a histogram processing sub-module, configured to perform contrast restricting processing on each block histogram in the M block histograms, to obtain M restricted block histograms, wherein the M restricted block histograms are in one-to-one correspondence with the M image blocks.

13. The display according to claim 12, wherein the mapping module comprises:
a histogram mapping sub-module, configured to perform equalization processing on the restricted block histograms to obtain M block mapping tables;
a filtering sub-module, configured to filter the M block mapping tables to obtain M filtering mapping tables.

14. The display according to claim 13, wherein the contrast enhancement device further comprises:
a histogram storage module, configured to store data of the M block histograms, data of the M restricted block histograms and data of the M block mapping tables in time division.

15. The display according to claim 14, wherein the data of the block histograms, the data of the restricted block histograms, and the data of the block mapping tables are stored in a static random access memory (SRAM).

16. The display according to claim 14, wherein the contrast enhancement device further comprises:
a filtering mapping table storage module, configured to store the M filtering mapping tables.

17. The display according to claim 16, wherein the calculation module is configured to:
interpolate the input image according to the M filtering mapping tables to obtain the target image with contrast enhancement.

18. The display according to claim 12, wherein the storage module stores the input image using a double data rate synchronous dynamic random access memory (DDR).

19. The display according to claim 16, wherein the contrast enhancement device further comprises:
a timing control module, configured to generate control signals required by the respective modules according to data of the input image.

20. The display according to claim 19, wherein the contrast enhancement device further comprises:
an image alignment module, configured to align the data of the input image with the control signal, and sending the data of the input image to the storage module by taking one row as one unit.
